(19) United States
(12) Patent Application Publication
(10) Pub. No.: US 2025/0245469 A1
(43) Pub. Date: Jul. 31, 2025

(54) CARDS, DEVICES, EMV CONTACTS, AND METHODS OF MANUFACTURING CARDS, DEVICES AND EMV CONTACTS

(71) Applicant: Dynamics Inc., Cheswick, PA (US)

(72) Inventors: Norman E. O'Shea, Seven Fields, PA (US); W. Barry Brown, Cheswick, PA (US); Jeffrey D. Mullen, Glenshaw, PA (US); Geoffrey D. Shippee, Edgeworth, PA (US)

(21) Appl. No.: 19/185,172

(22) Filed: Apr. 21, 2025

Related U.S. Application Data
(63) Continuation of application No. 14/472,827, filed on Aug. 29, 2014, now Pat. No. 12,282,816.
(60) Provisional application No. 61/876,208, filed on Sep. 10, 2013.

(51) Int. Cl. G06K 19/077

(52) U.S. Cl. CPC G06K 19/07743; G06K 19/07722

(57) ABSTRACT

A flexible device, such as a powered card or processor based system, may include a connector array. The connector array may be a contact connector such as an EMV connector. The connector array may include discrete connectors connected to landing pads of a circuit board. The discrete connectors may be exposed on a surface of the flexible device, and may be arranged in rows and columns. The discrete connectors may be formed using vias and by introducing material into the vias. A mask may be used to extend a level of the discrete connectors above an outer layer of the flexible device. A personalization layer may be applied to the flexible device to about a level of an outer surface of the connector. The flexible device may be programmed and tested during the application of the personalization layer.

### CROSS-REFERENCE TO RELATED APPLICATION

This application claims the benefit of U.S. patent application Ser. No. 14/472,827, titled “CARDS, DEVICES, EMV CONTACTS, AND METHODS OF MANUFACTURING CARDS, DEVICES AND EMV CONTACTS,” filed Aug. 29, 2014, issued as U.S. Patent No. 12,282,816 on Apr. 22, 2025, which claimed priority from Provisional Patent Application No. 61/876,208, titled “CARDS, DEVICES, EMV CONTACTS, AND METHODS OF MANUFACTURING CARDS, DEVICES AND EMV CONTACTS,” filed Sep. 10, 2013, now expired, which are all hereby incorporated by reference herein in their entirety.

### BACKGROUND OF THE INVENTION

This invention relates to powered cards and devices and related systems.

### SUMMARY OF THE INVENTION

According to some example embodiments, a card may include a connector array including a plurality of discrete connectors exposed on a surface of the card. The discrete connectors of the connector array may be arranged in rows and columns. The discrete connectors may be separated by at least a personalization layer.

According to some example embodiments, a method may include applying a personalization layer to a card; and programming the card during the applying a personalization layer.

According to some example embodiments a method may include applying a personalization layer to a card, and testing the card during the applying a personalization layer. The card may be tested during the applying a personalization layer.

### BRIEF DESCRIPTION OF THE DRAWINGS

The principles and advantages of the present invention can be more clearly understood from the following detailed description considered in conjunction with the following drawings, in which the same reference numerals denote the same structural elements throughout, and in which:

FIG. 1 is an illustration of a card constructed in accordance with the principles of the present invention;

FIG. 2 is an illustration of a card constructed in accordance with the principles of the present invention;

FIG. 3 is an illustration of a card constructed in accordance with the principles of the present invention; and

FIG. 4 illustrates process flow charts constructed in accordance with the principles of the present invention.

### DETAILED DESCRIPTION OF THE INVENTION

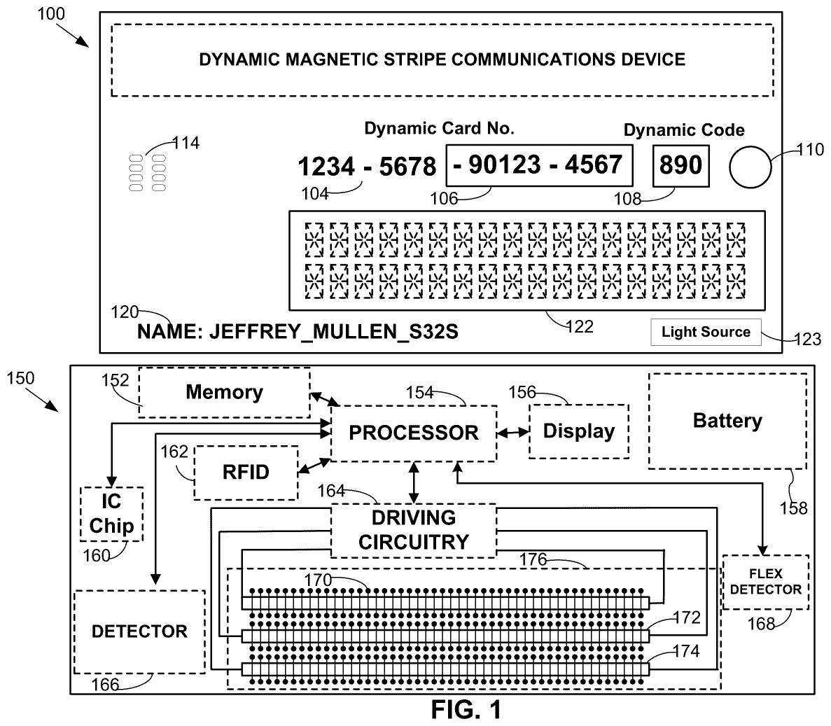

FIG. 1 shows card 100. Referring to FIG. 1, a card 100 may include, for example, a dynamic number that may be entirely, or partially, displayed using a display (e.g., display 106). A dynamic number may include a permanent portion such as, for example, permanent portion 104 and a dynamic portion such as, for example, a number displayed by display 106. Card 100 may include a dynamic number having permanent portion 104 and permanent portion 104 may be incorporated on card 100 so as to be visible to an observer of card 100. For example, labeling techniques, such as printing, embossing, laser etching, etc., may be utilized to visibly implement permanent portion 104.

Card 100 may include a second dynamic number that may be entirely, or partially, displayed via a second display (e.g., display 108). Display 108 may be utilized, for example, to display a dynamic code such as a dynamic security code. Card 100 may also include third display 122 that may be used to display, for example, graphical information, such as logos and barcodes. Third display 122 may also be utilized to display multiple rows and/or columns of textual and/or graphical information.

Persons skilled in the art will appreciate that any one or more of displays 106, 108, and/or 122 may be implemented as a bi-stable display. For example, information provided on displays 106, 108, and/or 122 may be stable in at least two different states (e.g., a powered-on state and a powered-off state). Any one or more of displays 106, 108, and/or 122 may be implemented as a non-bi-stable display. For example, the display is stable in response to operational power that is applied to the non-bi-stable display. Other display types, such as LCD or electro-chromic, may be provided as well.

Other permanent information, such as permanent information 120, may be included with card 100, which may include user specific information, such as the cardholder's name or username. Permanent information 120 may, for example, include information that is specific to card 100 (e.g., a card issue date and/or a card expiration date). Information 120 may represent, for example, information that includes information that is both specific to the cardholder, as well as information that is specific to card 100.

Card 100 may accept user input data via any one or more data input devices, such as button 110. Button 110 may be included to accept data entry through, for example, mechanical distortion, contact, and/or proximity. Button 110 may be responsive to, for example, induced changes and/or deviations in light intensity, pressure magnitude, or electric and/or magnetic field strength. Such information exchange may then be determined and processed by a processor of card 100 as data input.

Card 100 may be flexible. Card 100 may, for example, contain hardware and/or software (e.g., flex code stored in memory 152) that when executed by a processor of card 100 may detect when card 100 is being flexed. Flex code may be, for example, processor executable applications and/or may be one or more application specific integrated circuits, that may detect a change in operation of card 100 based on the flexed condition of card 100 and may alter functions of card 100 based on the detected change in operation.

According to at least one example embodiment, a processor of card 100 may receive a signal from a distortion detection element indicating an amount of flexure of card 100. A distortion detection element may be, for example, a microelectricalmechanical system (MEMS), such as a MEMS capacitor. A degree of flexure may be determined according to a signal from the MEMS (e.g., a signal representing a capacitance of the MEMS capacitor). Light Source 123 may provide an indication to a user of the level of flexure of card 100 based on the MEMS signal. For example, light source 123 may be a multicolored light emitting diode (LED) emitting light during flexure of card 100. A color of light source 123 may indicate whether a degree of flexure may result in damage to card 100 (e. g., green for acceptable flexure, yellow for borderline flexure and red for potentially damaging flexure).

Card 100 may include a connector 114 (e.g., an EMV connector). Connector 114 may include, for example, 8 exposed connection pads. According to some example embodiments, connector 114 may include 6 connection pads. The number of connection pads of connector 114 is not limited and may be, for example, any number of connection pads.

One or more of the connection pads may be connected to, for example, a processor of card 100 (e.g., an embedded processor) and may be configured to connect with an external interface device (e.g., a universal serial bus interface device). For example, a connection pad may be a power connection supplying operating power to a processor of card 100 from an interface device. As another example, a connection pad may supply a clock signal to a processor of card 100 from an interface device. As still another example, a connection pad may supply a reset signal to a processor of card 100 from an interface device. As yet another example, a connection pad may provide a common ground between an interface device and card 100. As still yet another example, a connection pad may be a programming power connection to program a memory (e.g., an EEPROM) of card 100. As a further example, a connection pad may be an input/output (I/O) line for communications between an interface device and card 100 (e.g., a half-duplex communication channel). As yet a further example, a connection pad may be unused and reserved for future use.

For example, card 100 may include two unused connection pads (e.g., a card 100 with 8 connection pads) and/or no unused connection pads (e.g., a card 100 with 6 connection pads). Persons of ordinary skill in the art will appreciate that a number of connection pads of connector 114 may be increased or decreased based on an interface device and/or uses of card 100. Each connection pad of connector 114 may be, for example, electrically isolated from every other connection pad. According to at least one example embodiment, one or more of the connection pads may be connected.

Although FIG. 1 shows connector 114 on one side of card 100, connector 114 may be exposed on a different side or on multiple sides (e.g., either the front or back, or both). According to some example embodiments, multiple connectors 114 may be included in card 100, for example, on the same side, different sides, and/or the same and different sides.

Connector 114 may conform to, for example, the International Organization for Standardization (ISO) 7816 generally, and/or may partially conform to ISO 7816 (e.g., positioning on card 100). According to at least one example embodiment, card 100 may not conform to ISO 7816.

FIG. 1 shows architecture 150, which may include one or more processors (e.g., processor 154 which may be a plurality of stacked processors). Processor 154 may be configured to utilize external memory 152, internal memory of processor 154, or a combination of external memory 152 and internal memory for dynamically storing information, such as executable machine language (e.g., flex code), related dynamic machine data, and user input data values. Processor 154 may, for example, execute code contained within memory 152 to detect when a card (e.g., card 100 of FIG. 1) is being flexed. The executed code may, for example, change the operation of a card (e.g., card 100 of FIG. 1) based on the detected change in operation and/or indicate a flexure state to a user (e.g., light source 123 of FIG. 1).

Processor 154 may be a single die, or a combination of two or more die stacked on top of one another. A die may be a thin die attached to a thin and flexible substrate and/or to another die. For example, stacked dies may be flexibly adhered to a mechanical carrier (e.g., a flexible printed circuit board (PCB)), and to each other, using flexible, non-anaerobic, low ionic adhesive. A low ionic adhesive may be an adhesive that includes relatively little (e.g., less than about 20 ppm) or no ionic species that may affect device operation (e.g., migratory species in semiconductor devices) and/or that acts as a barrier to such ionic species.

One or more of the components shown in architecture 150 may be configured to transmit information to processor 154 and/or may be configured to receive information communicated by processor 154. For example, one or more displays 156 may be coupled to receive data from processor 154. The data received from processor 154 may include, for example, at least a portion of dynamic numbers and/or dynamic codes.

One or more displays 156 may be, for example, touch sensitive, signal sensitive and/or proximity sensitive. For example, objects such as fingers, pointing devices, and the like may be brought into contact with displays 156, or in proximity to displays 156. Objects such as light and/or sound emitting device may be aimed at displays 156. Detection of signals, object proximity or contact with displays 156 may be effective to perform any type of function communicate data to processor 154). Displays 156 may have multiple locations that are able to be determined as being touched, or determined as being in proximity to an object. As one non-limiting example, display 156 may be a thin film transistor (TFT) array (e.g., semiconductor oxide TFT array) configured to receive and emit light.

Input and/or output devices may be implemented on architecture 150. For example, integrated circuit (IC) chip 160 (e.g., an EMV chip) may be included within architecture 150, that may communicate information to a chip reader (e.g., an EMV chip reader). For example, chip 160 may be connected to, and communicate using, connection pads of a connector (e.g., contact communication) and/or an antenna (e.g., contactless communication). Chip 160 may or may not be connected to processor 154. For example, chip 160 may be an exposed chip and processor 154 may be an unexposed chip. Processor 154 may selectively determine information exposed via chip 160, for example, to improve security of card 100. Radio frequency identification (RFID) module 162 may be included within architecture 150 to enable the exchange of information with an RFID reader/writer.

Other input and/or output devices may be included within architecture 150, for example, to provide any number of input and/or output capabilities. For example, input and/or output devices may include an audio and/or light device operable to receive and/or communicate audible and/or light-based information. Input and/or output devices may include a device that exchanges analog and/or digital data using a visible data carrier. Input and/or output devices may include a device, for example, that is sensitive to a non-visible data carrier, for example, an infrared data carrier or an electromagnetic data carrier.

Flex detector 168 may detect flexure of a device (e.g., card 100). For example, flex detector 168 may include a distortion detection element operable to detect an amount of flexure of a device. Flex detector 168 may be, for example, a MEMS detector, piezoelectric element, detection circuitry, and/or the like.

Persons skilled in the art will further appreciate that a card (e.g., card 100 of FIG. 1) may, for example, be a self-contained device that derives its own operational power from one or more batteries 158. One or more batteries 158 may be included, for example, to provide operational power for a period of time (e.g., approximately 2-4 years). One or more batteries 158 may be included, for example, as rechargeable batteries.

Electromagnetic field generators 170-174 of dynamic magnetic stripe communications device 176 may be included within architecture 150 to communicate information to, for example, a read-head of a magnetic stripe reader via, for example, electromagnetic signals. For example, electromagnetic field generators 170-174 may be included to communicate one or more tracks of electromagnetic data to read-heads of a magnetic stripe reader. Electromagnetic field generators 170-174 may include, for example, a series of electromagnetic elements. Each electromagnetic element may be implemented as a coil encircling one or more materials (e.g., a magnetic material and/or a non-magnetic material). Additional materials may be outside the coil (e.g., a magnetic material and/or a non-magnetic material).

Electrical excitation by processor 154 of one or more coils of one or more electromagnetic elements via, for example, driving circuitry 164 may generate electromagnetic fields from the one or more electromagnetic elements. One or more electromagnetic field generators 170-174 may be utilized to communicate electromagnetic information to, for example, one or more read-heads of a magnetic stripe reader.

Timing aspects of information exchange between architecture 150 and the various I/O devices implemented within architecture 150 may be determined by processor 154 and/or by an external interface device connected to card 100. Detector 166 may be utilized, for example, to sense the proximity and/or actual contact, of an external device, which in turn, may trigger the initiation of a communication sequence. The sensed presence and/or touch of the external device may then be communicated to a controller (e.g., processor 154), which in turn may direct the exchange of information between architecture 150 and the external device. The sensed presence and/or touch of the external device may be effective to, for example, determine the type of device or object detected.

For example, the detection may include the detection of a read-head of a magnetic stripe reader. In response, processor 154 may activate one or more electromagnetic field generators 170-174 to initiate a communications sequence with, for example, one or more read-heads of a magnetic stripe reader. The timing relationships associated with communications between one or more electromagnetic field generators 170-174 and one or more read-heads of a magnetic stripe reader may be based on a detection of the magnetic stripe reader. As another example, the detection may include detection of an interface device connected to chip 160 (e.g., via exposed connection pads of card 100).

Persons skilled in the art will appreciate that processor 154 may provide user-specific and/or card-specific information through utilization of one or more buttons (e.g., button 110), connector 114, RFID 162, IC chip 160, electromagnetic field generators 170-174, and/or other input and/or output devices.

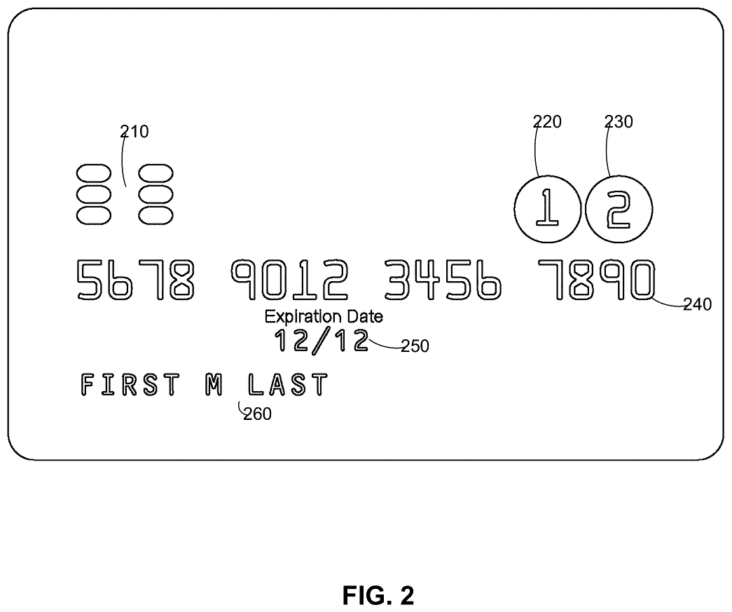

FIG. 2 is an illustration of a card constructed in accordance with the principles of the present invention. Referring to FIG. 2, card 200 may include connector array 210, buttons 220 and 230, and information 240, 250 and 260.

Card 200 may include a connector array 210 (e.g., an EMV connector). Connector array 210 may include, for example, 6 discrete connectors. Each discrete connector may be exposed on a surface of card 200. According to some example embodiments, each discrete connector may include contact pads on the surface of card 200.

One or more of the discrete connectors may connect an external interface device (e.g., a universal serial bus interface device) to card 200. For example, a discrete connector may be a power connection supplying operating power to a processor (not shown) of card 200 from an interface device. As another example, a discrete connector may supply a clock signal to a processor of card 200 from an interface device. As still another example, a discrete connector may supply a reset signal to a processor of card 200 from an interface device. As yet another example, a discrete connector may provide a common ground between an interface device and card 200. As still yet another example, a discrete connector may be a programming power connection used to program a memory (not shown) of card 200. As a further example, a discrete connector may be an input/output (I/O) pad used for communications between an interface device and card 200 (e.g., a half-duplex communication channel).

The discrete connectors of connector array 210 communicatively connected (e.g., 210 may be electrically connected) to land patterns (e.g., conductive pads) (not shown) on one or more boards, for example, a flexible printed circuit board (not shown) of card 200. The discrete connectors may extend from the one or more boards through, for example, vias and/or routing paths. The vias and/or routing paths may extend through outer layers on a surface of card 200 to expose the discrete connectors. Connector array 210 may connect card 200 to a contact reader, for example, an EMV reader.

According to at least one other example embodiment, connector array 210 may include a conventional EMV contact structure. The discrete connectors of connector array 210 may be formed on the contact structure by an additive process, for example, adding additional connective material (e.g., conductive material) and adding a non-connective material around the connective material. Persons of ordinary skill in the art will appreciate that other processes are within the scope of example embodiments. For example, an etch and/or damascene process.

Each discrete connector of connector array 210 may be, for example, electrically isolated from every other discrete connector. According to at least one example embodiment, one or more of the discrete connectors may be connected. Connector array 210 may include, for example, aluminum, nickel, gold, copper, silicon, palladium silver, palladium gold, platinum, platinum silver, platinum gold, tin, kovar (e.g., nickel-cobalt ferrous alloy), stainless steel, iron, ceramic, brass, conductive polymer, zinc and/or carbide.

Although FIG. 2 shows connector array 210 on one side of card 200, connector array 210 may be exposed on a different side or on multiple sides of card 200 (e.g., either the front or back, or both). Multiple connectors 210 may be included on card 200. Connector array 210 may conform to the International Organization for Standardization (ISO) 7816 generally, and/or may partially conform to ISO 7816 (e.g., positioning on card 200). According to at least one example embodiment, card 200 may not conform to ISO 7816.

A shape of the discrete connectors of connector array 210, and/or the exposed portions of the discrete connectors, may be any shape. For example, the discrete connectors, and/or the exposed portions of the discrete connectors, may be square, rectangular, oval, semi-circular, triangular, quadrilateral and/or circular. The shape of the discrete connectors may be stylized, for example, star shaped, shield shaped, shaped as a natural object (e.g., an apple), as a logo (e.g., a corporate logo) and/or any other shape. Each discrete connector may include more than four sides (e.g., hexagonally shaped). According to at least one example embodiment, each connector may be shaped as a rectangle with rounded corners and/or ends. According to some example embodiments, one, some or all of the discrete connectors, and/or the exposed portion of the discrete connectors, may be shaped differently.

Card 200 may include buttons 220 and 230. Card 200 may provide user-specific and/or card-specific information upon utilization of one or more of buttons 220 and 230. Card 200 may include one or more displays (not shown). Card 200 may include information 240, 250 and 260. For example, information 240 may be, for example, an embossed and/or printed account number. Information 250 may be, for example, an expiration date associated with card 200. Information 260 may be, for example, a name of a cardholder.

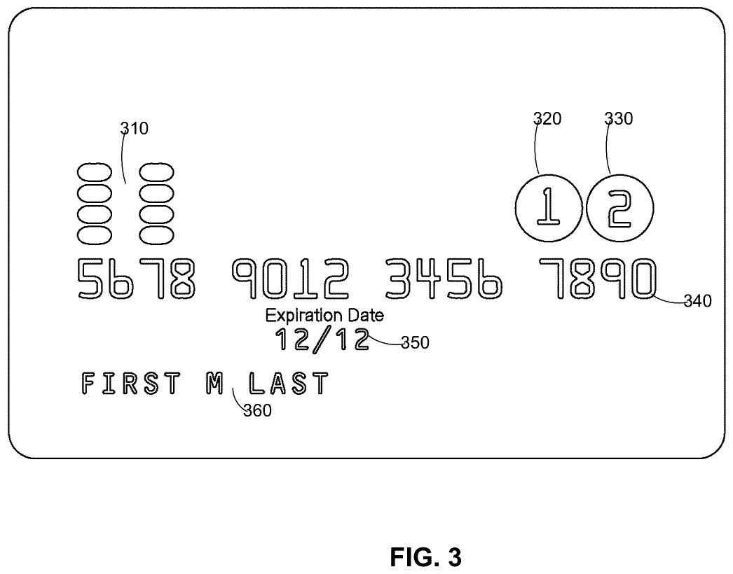

FIG. 3 is an illustration of a card constructed in accordance with the principles of the present invention. Referring to FIG. 3, card 300 may include connector array 310, buttons 320 and 330, and information 340, 350 and 360.

Card 300 may include a connector array 310 (e.g., an EMV connector). Connector array 310 may include, for example, 8 discrete connectors. Each discrete connector may be exposed on a surface of card 300. According to some example embodiments, each discrete connector may include contact pads on the surface of card 200.

One or more of the discrete connectors may connect an external interface device (e.g., a universal serial bus interface device) to card 300. For example, a discrete connector may be a power connection supplying operating power to a chip (not shown) of card 300 from an interface device. As another example, a discrete connector may supply a clock signal to a chip of card 300 from an interface device. As still another example, a discrete connector may supply a reset signal to a chip of card 300 from an interface device. As yet another example, a discrete connector may provide a common ground between an interface device and card 300. As still yet another example, a discrete connector may be a programming power connection used to program a memory (not shown) of card 300. As a further example, a discrete connector may be an input/output (I/O) pad used for communications between an interface device and card 300 (e.g., a half-duplex communication channel). As yet a further example, one or more of the discrete connectors may be unused and reserved for future use.

The discrete connectors of connector array 310 may be communicatively connected (e.g., electrically connected) to land patterns (e.g., conductive pads) (not shown) on one or more boards, for example, a flexible printed circuit board (not shown) of card 300. The discrete connectors may extend from the one or more boards through, for example, vias and/or routing paths. The vias and/or routing paths may extend through outer layers on a surface of card 300 and the discrete connectors may be exposed on a surface of card 300. Connector array 310 may connect card 300 to a contact reader, for example, an EMV reader.

According to at least one other example embodiment, connector array 310 may include a conventional EMV contact structure. The discrete connectors of connector array 310 may be formed on the contact structure by an additive process, for example, adding additional connective material (e.g., conductive material) and adding a non-connective material around the connective material. Persons of ordinary skill in the art will appreciate that other processes are within the scope of example embodiments. For example, an etch and/or damascene process.

Each discrete connector of connector array 310 may be, for example, electrically isolated from every other discrete connector. According to at least one example embodiment, one or more of the discrete connectors may be connected. Connector array 310 may include, for example, a conductor. For example, discrete connectors may include aluminum, nickel, gold, copper, silicon, palladium silver, palladium gold, platinum, platinum silver, platinum gold, tin, kovar (e.g., nickel-cobalt ferrous alloy), stainless steel, iron, ceramic, brass, conductive polymer, zinc and/or carbide.

Although FIG. 3 shows connector array 310 on one side of card 300, connector array 310 may be exposed on a different side or on multiple sides of card 300 (e.g., either the front or back, or both). Multiple connectors 310 may be included on card 300. Connector array 310 may conform to the International Organization for Standardization (ISO) 7816 generally, and/or may partially conform to ISO 7816 (e.g., positioning on card 300). According to at least one example embodiment, card 300 may not conform to ISO 7816.

A shape of the discrete connectors of connector array 310, and/or the exposed portions of the discrete connectors, may be any shape. For example, the discrete connectors, and/or the exposed portions of the discrete connectors, may be square, rectangular, oval, semi-circular, triangular, quadrilateral and/or circular. The shape of the discrete connectors may be stylized, for example, star shaped, shield shaped, shaped as a natural object (e.g., an apple), as a logo (e.g., a corporate logo) and/or any other shape. Each discrete connector may include more than four sides (e.g., hexagonally shaped). According to at least one example embodiment, each connector may be shaped as a rectangle with rounded corners and/or ends. According to some example embodiments, one, some or all of the discrete connectors, and/or the exposed portion of the discrete connectors, may be shaped differently.

Card 300 may include buttons 320 and 330. Card 300 may provide user-specific and/or card-specific information upon utilization of one or more of buttons 320 and 330. Card 300 may include one or more displays (not shown). Card 300 may include information 340, 350 and 360. For example, information 340 may be, for example, an embossed and/or printed account number. Information 350 may be, for example, an expiration date associated with card 300. Information 360 may be, for example, a name of a cardholder.

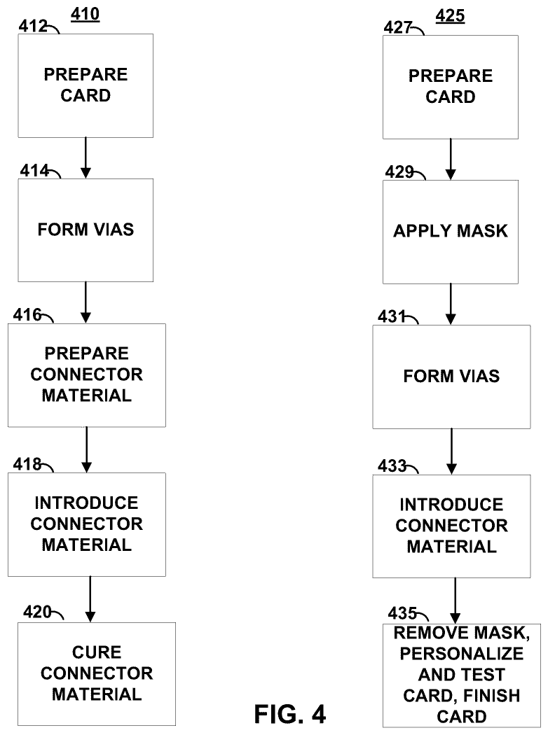

FIG. 4 illustrates process flow charts constructed in accordance with the principles of the present invention. Referring to Referring to FIG. 4, sequence 410 may include, for example, preparing a card (e.g., as in step 412). The card may include a circuit board (e.g., a flexible printed circuit board) with a conductive landing pad, and one or more layers on the board. At least one via (e.g., 6 or 8 vias) may be formed in the one or more layers to expose the landing pad (e.g., as in step 414). For example, a digitally controlled carbon dioxide laser including ‘Galvo’ mirrors may be programmed, and may etch a selected number of vias through the outer layer (e.g., plastic outer layer) of the card. The laser may etch through other materials if present, for example, an adhesive system used to bond the outer layer to the circuit board. A shape of each via may be programmed and the laser may etch each via in any shape.

A depth and shape of the vias may be determined to decrease and/or minimize damage to a contact area of the landing pad. The landing pad may be, for example, gold plated. The laser may be programmed such that residue from the etched material is removed to improve adhesion and electrical conductivity. Each via etched into the card may be, for example, a vertical tube between the surface of the card and the landing pads on the circuit board.

A connector material may be prepared (e.g., as in step 416). The connector material may include, for example, one or more conductive materials. Each of the materials may include, for example, aluminum, nickel, gold, copper, silicon, palladium silver, palladium gold, platinum, platinum silver, platinum gold, tin, kovar (e.g., nickel-cobalt ferrous alloy), stainless steel, iron, ceramic, brass, conductive polymer, zinc and/or carbide.

The connector material may include, for example, an epoxy system. The one or more connector materials may be blended into a matrix with an epoxy system. The epoxy system may be, for example, either a “1 part system” or a “2 part system.” The epoxy system may be cured using ambient moisture and/or air, thermally cured and/or reaction base cured using resin and a hardener. An epoxy system may be selected based on conductive durability, physical durability, electrical durability, abrasion resistance, chemical resistance, scalability and cost.

The connector material may be introduced into the vias (e.g., as in step 418) to form discrete connectors from landing pads to about the surface of the card. For example, a robotically controlled dispensing method may be used to fill and/or partially fill each individual via. According to at least one example embodiment, the connector material may be deposited into each via such that a cured surface of the conductor film is at about a finished card surface and/or a pad is formed at about a finished card surface. According to at least one example embodiment, a level of the cured surface may be determined based on ISO standards for EMV physical dimensions and/or subsequent processing.

As another example, the connector film may be forced hydraulically into the vias and then cured (e.g., ‘stencil printing’).

The connector material may be cured (e.g., as in step 420). Curing may improve physical and electrical properties of the epoxy system. Pads formed with the connector material at the card surface may be above that required by ISO standards for a finished card. According to some example embodiments, a mechanized abrading system may be used to true up the surface of the pads and bring them to the target height (e.g., a height required to accommodate the printing process and meet ISO height standards).

Sequence 425 may include, for example, preparing a card (e.g., as in step 427). The card may include an electronics package between card layers, for example, transparent plastic card layers. A mask (e.g., a stencil) may be applied to the card (e.g., as in step 429). The mask may be, for example, any type of mask. For example, the mask may be a paper or cardboard mask.

At least one via (e.g., 6 or 8 vias) may be formed through the mask and at least one layer of the card to expose a landing pad of a board (e.g., as in step 431). For example, the mask and the card layer may be etched (e.g., using a laser) to form at least one via including openings in the mask, any card layers and any other materials between the mask and the landing pad. A connector material may be introduced into the at least one via (e.g., as in step 433) through the etched portions of the mask. The connector material may fill and/or partially fill the via to form a connector from the landing pad to about the outside surface of the mask.

The mask may be removed, and the card personalized, tested and finished (e.g., as in step 435). For example, the mask may be removed to expose an outer surface of the card and at least one connector protruding above the outer surface. Personalization may include, for example, providing color, graphics and/or information to an outer surface of the card. At least one personalization layer may be applied to the card until an outer surface of the at least one connector is at about the level of an outer surface of the card (e.g., the card including the personalization layer). For example, the card may be printed with one or more materials (e.g., a plurality of layers) until the printed material is about flush with the outer surface of the connector. The printing may be, for example, drop-on-demand printing.

According to some example embodiments, a material removal process may be used to lower the outer surface of the connector in a case where the connector is not flush and protrudes from the outer surface of the personalization layer. The material removal process may include a planar polish and/or the use of a mechanized abrading system.

Personalization of the card may include, for example, programming the card. Programming according to example embodiments may occur while a personalization layer is being applied to the card. For example, the card may be programmed during a drop-on-demand printing process using a communication device of the card. Programming may include communicating with, for example, one or more inductive sensors (e.g., read-head sensors), one or more dynamic magnetic stripe communications devices, one or more infrared communications devices, an RFID, an IC chip, and/or any other communication device.

According to at least one example embodiment, a material of the personalization layer may be a conductive communication path with the at least one connector. The card may be programmed during application of the personalization layer by communicating signals through the material of the personalization layer. Signals may be communicated, for example, to a processor, memory and/or IC chip via the material of the personalization layer and the at least one connector.

The card may be tested. Components of the card may be triggered to verify operation of the card. Any communication device may be activated. Test results may be communicated through the communication device and/or testing may include verifying operation of the communication device.

Testing of the card may occur, for example, after programming and during application of the personalization layer. According to some example embodiments, both programming and testing may be performed while the card is printed.

Persons skilled in the art will appreciate that the present invention is not limited to only the example embodiments described. Instead, the present invention more generally involves dynamic information and the exchange thereof. Features described with respect to an example embodiment may be utilized in different example embodiments. Persons skilled in the art will also appreciate that the apparatus of the present invention may be implemented in other ways than those described herein. All such modifications are within the scope of the present invention, which is limited only by the claims that follow.

What is claimed is:

1. A card comprising: a flexible substrate; a processor coupled to the flexible substrate; a distortion detection element coupled to the processor and operable to detect an amount of flexure of the flexible substrate; and an indicator coupled to the processor, wherein the processor is configured to activate the indicator to provide a visual indication representative of the amount of flexure detected by the distortion detection element.

2. A card comprising: a substrate; a plurality of displays coupled to the substrate, wherein each of the plurality of displays is independently operable to display dynamic information; and a processor coupled to the plurality of displays, wherein the processor is configured to individually control the plurality of displays to present different dynamic information simultaneously.

3. A card comprising: an integrated circuit (IC) chip; a plurality of electromagnetic field generators operable to communicate electromagnetic signals representing magnetic stripe data; and a detector coupled to the IC chip, wherein the detector is operable to detect the presence of an external interface device, and wherein the IC chip is configured to activate at least one of the electromagnetic field generators in response to the detected presence of the external interface device.

4. The card of claim 1, wherein the distortion detection element comprises a microelectromechanical system (MEMS) sensor.

5. The card of claim 1, wherein the distortion detection element is a MEMS capacitor.

6. The card of claim 1, wherein the indicator comprises a multicolored light emitting diode (LED).

7. The card of claim 6, wherein the LED emits different colors based on different degrees of flexure.

8. The card of claim 1, wherein the flexible substrate comprises a flexible printed circuit board (PCB).

9. The card of claim 2, wherein at least one of the plurality of displays is a bi-stable display.

10. The card of claim 2, wherein at least one of the plurality of displays is a thin film transistor (TFT) array.

11. The card of claim 2, wherein at least one of the plurality of displays is touch sensitive.

12. The card of claim 2, further comprising at least one input button coupled to the processor and operable to accept user input.

13. The card of claim 12, wherein the at least one input button is responsive to at least one of mechanical distortion, contact, and proximity.

14. The card of claim 3, wherein the detector is operable to detect a magnetic stripe reader.

15. The card of claim 3, wherein the detector comprises a proximity sensor.

16. The card of claim 3, wherein the IC chip is configured to selectively determine information exposed to the external interface device.

17. The card of claim 3, further comprising at least one battery coupled to supply operational power to the IC chip and the electromagnetic field generators.

18. The card of claim 3, wherein the electromagnetic field generators comprise a plurality of coils.

19. The card of claim 18, wherein each coil encircles a material selected from the group consisting of magnetic materials and non-magnetic materials.

20. The card of claim 3, further comprising a personalization layer configured to provide a conductive communication path to the IC chip.
